(19) United States
(12) Patent Application Publication
(10) Pub. No.: US 2004/0240529 A1
(43) Pub. Date: Dec. 2, 2004

(54) Discontinuous transmission detection method

(76) Inventors: Eric David Leonard, Morris Township, NJ (US); Henry Hui Ye, Ledgewood, NJ (US)

Correspondence Address: CARLSON, GASKEY & OLDS, P.C., 400 WEST MAPLE ROAD, SUITE 350, BIRMINGHAM, MI, 48009, US

(21) Appl. No.: 10/446,994

(22) Filed: May 28, 2003

(51) Int. Cl. H04B 1/707

(52) U.S. Cl. 375/148

(57) ABSTRACT

A DTX detection method evaluates soft symbols from a decoding process to evaluate whether a checksum error is caused by an erasure condition or a DTX condition. The inventive method divides the soft symbols or a function of the soft symbols by a normalizing factor that greatly reduces the effect of the overall magnitude of the channel estimates that are used to calculate the soft symbols, restoring a value proportional to the received symbol energy. The method then evaluates this value, rather than the unnormalized value, to determine whether a checksum error for the frame is caused by a DTX condition or an erasure condition. Normalizing the soft symbols to obtain a metric proportional to the actual symbol energy greatly reduces the effect of the overall channel level on DTX detection, making it easier to distinguish between DTX cases and erasure cases.

### BACKGROUND OF THE INVENTION

1. Field of the Invention

The present invention relates to wireless communication systems.

2. Description of the Related Art

Communication systems, such as wireless systems are designed to meet various demands of subscribers. Service providers continuously seek ways to improve the overall performance of the communication system. As wireless communications become more and more popular for subscribers to obtain data (i.e., e-mail or information from the internet), communication systems must be capable of a higher throughput and be tightly controlled to maintain a high quality of service. Communication is conducted according to any desired communications standard, such as the Universal Mobile Telecommunications Standard (UMTS) or a CDMA standard.

As is known in the art and shown in FIG. 1, a given service coverage area 100 is divided into multiple cells 102, with a base station 104 associated with one or more cells. A scheduler (not shown) at the base station selects a user for transmission at a given time, and adaptive modulation and coding allows selection of an appropriate transport format (modulation and coding) for the current channel conditions seen by the user. There are two directions of data flow in such systems. Communications from the base station 104 to a mobile device 106 are considered to flow in a downlink direction while the communications originating at the mobile device and sent to the base station are considered to flow in an uplink direction.

In some cases, such as during transmission of supplemental channels or digital control channels, the communications standard allows the mobile device to decide on its own discretion, on a frame-by-frame basis, whether to send a packet of data to the base station. In this situation, the mobile device does not notify the base station whether or not it has sent symbols making up the frame. Instead, the base station itself must figure out if the mobile device sent a frame.

To do this, the base station receives a checksum value, which is normally included at the end of a frame. If the base station receives a checksum that matches an expected checksum, then the base station can safely assume that the mobile device transmitted a frame and that the data in the frame is good data.

If the received checksum does not match and causes a checksum error, the base station 104 is not able to tell whether the mobile device actually sent a frame. One possible cause of a checksum error is a transmitted frame that became garbled during transmission by, for example, poor channel conditions. In other words, the mobile device tried to transmit a frame but the frame was not received correctly by the base station. This cause is called an “erasure.”

Another possible cause of a checksum error is when the mobile device chose not to send a frame at all; this cause is called a “discontinuous transmission,” or DTX. This may occur if, for example, the mobile device did not have any data to send to the base station. Even though in this case the mobile device did not send any data, the base station has no way of knowing that. Because the base station decodes each frame while assuming that the mobile device is continuously sending frames, the base station will virtually always detect a checksum error at a time when a frame was not sent.

Thus, if a checksum error occurs, the base station 104 needs to know whether the error was caused by a garbled transmitted frame (erasure) or whether the base station incorrectly detected a non-existent frame (DTX) to take appropriate corrective action, such as adjusting the mobile device's transmission power.

One currently known DTX detection algorithm is based on symbol error rates. This approach is used for convolutional codes and involves re-encoding estimated data bits generated by the convolutional decoder to generate estimated symbols and then comparing the estimated data symbols with the actual received symbols to compute the number of symbol errors. If there are many errors, the base station assumes that the mobile device did not send any symbols (i.e., a DTX case), making more of the received symbols an error. If there are fewer errors, the base station assumes that the mobile device did send symbols and that the base station failed to decode them correctly back into the original data bits. Histograms of the respective symbol error rates of DTX cases and erasure cases provide a guide as to the threshold at which DTX cases can be distinguished from erasure cases. Ideally, these histograms are clearly separated, with symbol error rates above the threshold corresponding to a DTX case and symbol error rates below the threshold corresponding to the erasure case. However, there is usually some overlap where a given symbol error rate does not clearly indicate an erasure case or a DTX case. This overlap makes it possible to mistakenly identify a DTX case as an erasure or vice versa.

Another DTX detection approach measures the pilot energy and classifies a checksum error as being caused by an erasure if channel conditions are poor as indicated by a low measured pilot energy. The logic behind this approach is that erasures tend to occur during these conditions. However, pilot energies can also be low during DTX cases, creating a high probability of misclassifying a DTX case as an erasure.

Yet another DTX detection approach sums the absolute values of the symbols in the transmitted frame and compares this sum with a threshold value. Because no symbols are transmitted during a DTX case, the sum would theoretically indicate an erasure case if it exceeds a given threshold. However, the sum is sensitive to channel conditions, causing a large overlap between values corresponding to DTX cases and erasure cases.

The performance of a DTX algorithm is measured by the probability that the algorithm will misclassify an erasure as a DTX (referred to as P(D|E) or missed detection) and the probability that it will misclassify a DTX as an erasure (referred to as P(E|D) or false detection). Regardless of the specific DTX detection method, decreasing the probability of one misclassification type will increase the probability of the other misclassification type.

There is a desire for a method that can reliably distinguish erasures from DTXs.

### SUMMARY OF THE INVENTION

The present invention is directed to a DTX detection method based on received soft symbols for a given frame. The soft symbols are typically obtained by taking the complex outputs of a despreader and multiplying them by the complex conjugates of their corresponding channel estimates. This multiplication process simultaneously scales the symbols for subsequent maximum ratio combining and de-rotates the symbols. The inventive method divides the soft symbols or a function of the soft symbols by a normalizing factor that removes the scaling effect of this multiplication process on the soft symbols to obtain a normalized result. As a result, the expected value of the normalized metric does not depend on the overall level of the pilot signal. The inventive method evaluates the normalized result, rather than the unnormalized result, of the multiplication process to determine whether a checksum error for the frame is caused by a DTX condition or an erasure condition.

In one embodiment, the same normalization factor is applied to all of the soft symbols in the given frame. This allows high energy symbols to be weighted more than low energy symbols, which increases accuracy in detecting erasure cases.

By normalizing a function of the soft symbol values to remove the scaling effect of the channel estimates on the soft symbol values, the inventive method greatly reduces the effect of channel conditions on the DTX case. Further, because one normalization factor is applied to the soft symbols at the end of the inventive process in one embodiment, the inventive method preserves the relative weighting among the symbols from the decoding process, allowing effective channel sensitive symbol combination for the erasure case. As a result, the invention provides a simple way to distinguish DTX cases and erasure cases more accurately.

### BRIEF DESCRIPTION OF THE DRAWINGS

FIG. 1 is a representative diagram of an operating environment of the invention;

FIG. 2 is a flow diagram of one embodiment of the invention;

FIG. 3 is a table comparing DTX detection performance according to various methods; and

FIGS. 4 through 6 are sample graphs illustrating DTX detection at different data transmission rates.

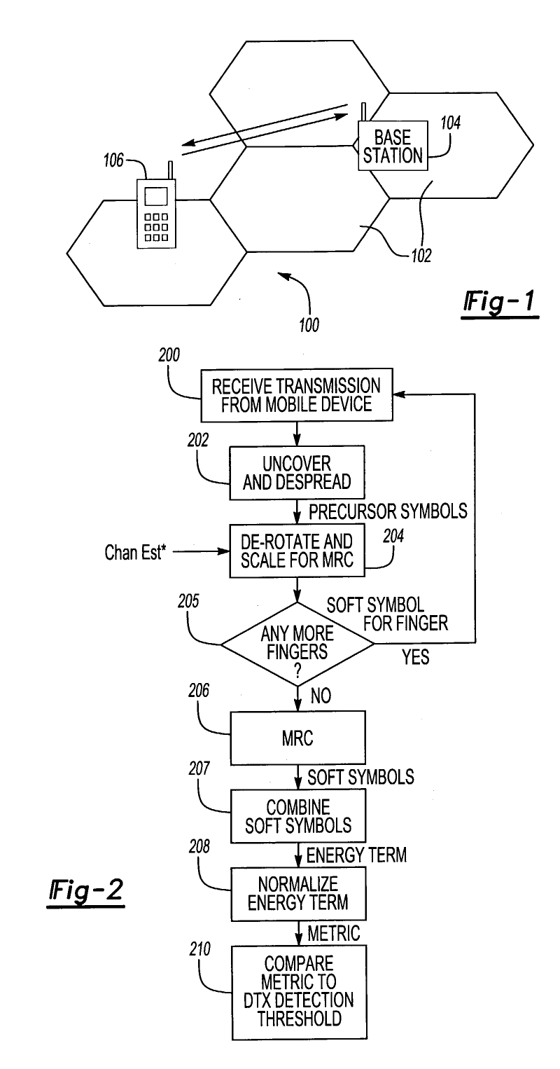

### DETAILED DESCRIPTION

As noted above, one possible DTX detection algorithm detects a DTX case based on a sum of the magnitudes of all the symbols in a given frame. This type of algorithm relies on evaluating soft symbols decoded by maximum ratio combining. Soft symbols are derived from two components that are multiplied together for each combining finger: (1) the precursor symbols obtained after the dispreading process and (2) the complex conjugate of their corresponding channel estimates. Typically, soft symbols are obtained in the decoding process by taking complex outputs from a despreader and then multiplying them by the complex conjugates of their corresponding channel estimates. This multiplication process simultaneously scales and derotates the symbols for subsequently maximum ratio combining.

The channel estimate is obtained by monitoring a pilot signal from the mobile device. The base station accumulates the pilot signal through a filter over time to determine how strong the signal is and to obtain the phase of the signal, which is used to conduct de-rotation and scaling during decoding.

Because the channel estimate can vary widely as channel conditions change, the soft symbol energy will vary widely as well, making it difficult to identify an energy range that is clearly identifiable as an energy range caused by a DTX case. If the channel conditions are good (e.g., if the channel is exhibiting high energy), the symbol energy will be higher than if the channel conditions are poor. As a result, a non-existent (DTX) frame on a high-power channel may have the same symbol energy as a transmitted frame on a low-power channel, making it easy to confuse noise with actual data when attempting to distinguish between an erasure and a DTX.

For example, assume that channel A has a channel estimate that is twice the magnitude as channel B. Furthermore, assume that no data is transmitted over either channel (i.e., the frame being evaluated is a DTX frame). Then, the soft symbol energy associated with the frame sent over channel A will be twice as high as the soft symbol energy for the frame sent over channel B even though both represent the same DTX case. In a DTX situation, the strong channel estimate in channel A may multiply noise in the channel to the point where the noise will have the same magnitude as an erasure frame transmitted through channel B even though no symbols are being sent through channel A. This is true even though there are no symbols being transmitted in a DTX situation. This makes it difficult to distinguish between the DTX situation and an erasure among different channels.

The present invention solves this problem by greatly reducing the effects of channel conditions from the overall soft symbol energy value for the DTX case. In other words, symbols from the DTX case will have the same expected value for their calculated metric even if the symbols are transmitted over channels having different channel estimates. Generally, the inventive method involves normalizing the sum of the soft symbols to remove the overall scaling effect of channel conditions in a given DTX frame. In other words, the normalization removes the overall scaling effect of the maximum ratio combining process that was previously applied to obtain the overall soft symbol energy value. As a result of this normalization, the symbol energy metric for a given frame remains substantially constant for all DTX cases, regardless of the channel estimates, making DTX cases easier to detect from erasures

The DTX detection algorithm, according to the invention, relies on a calculated metric to distinguish between the DTX and erasure cases. Equation 1 below illustrates one way of obtaining the metric. This equation normalizes the magnitude of the soft symbol energy in a given frame to greatly reduce the effect of channel conditions. The metric used to distinguish erasures from DTXs can be calculated as follows:

$$\frac{{\sum }_{Symb}^{} \vert Soft\_Symbol ( Symb ) \vert}{\begin{matrix}{Σ}_{ChanEstNum}^{} \sqrt{{\sum }_{Finger}^{} {‖ ChanEst ( ChanEstNum , Finger ) ‖}^{2}} * \\ Combine ( ChanEstNum , Finger )\end{matrix}} \qquad ( Equation 1 )$$

As is known in the art, the symbols in a frame may reach the cell over multiple transmission paths, or fingers, with the symbols from each finger reaching the base station 104 at slightly different times. Each precursor symbol of a finger is then multiplied by the complex conjugate of its corresponding channel estimate. The products of these precursor symbols and channel estimates are then combined to obtain the soft symbol energy for the entire frame (i.e. the numerator in Equation 1), which is also referred to as a maximum ratio combining (MRC) energy term. Note that the combining process can be any constant ratio combining process and is not limited to MRC. In one embodiment, the base station ignores symbols from fingers having finger channel estimates that are considered too weak for consideration and assigns a Boolean Combine value of 0 for these weak fingers. Fingers to be considered in calculating the soft symbol energy are given a Boolean Combine value of 1.

As explained above, the maximum ratio combining process used to calculate the soft symbol energy multiplies the precursor symbols by the channel estimates corresponding to those symbols. Thus, good channel conditions will multiply any noise in the channel and make this sum high, making it look as if the mobile device transmitted symbols even though it is actually in a DTX condition.

The inventive method compensates for this via the denominator. Again, note that the Boolean Combine value equals 1 for a given finger when that finger is used to generate soft symbols and equals 0 if the finger is not used. Hence, only channel estimates that were part of the combining process are used to calculate the denominator. The denominator in Equation 1 is the normalizing factor, which is calculated by combining the effects of all channel estimates used to generate the soft symbol energy. As can be seen in Equation 1, the normalizing factor is equal to a sum of finger-combined channel estimate norms, where each finger combined channel estimate norm represents a square root of a sum of squared norms of the finger channel estimates used to generate the soft symbols. Because the soft symbol energy is calculated by multiplying the precursor symbols with the complex conjugates of their corresponding channel estimates, the numerator in Equation 1 will be proportional to the denominator.

Dividing the soft symbol energy by the normalizing factor removes the overall scaling effect of the channel estimates on the metric and recovers a value proportional to the actual symbol energy, uncorrupted by the overall strength of the received pilot. This reduces the variance of the metric in the DTX case and makes it easier to distinguish between erasures and DTXs. More particularly, Equation 1 creates a metric that allows evaluation of the actual received symbol energies, uninfluenced by channel conditions for the DTX case. For example, if a checksum error occurs and the metric reflects a low or no symbol energy, this reflects the fact that few or no symbols were transmitted, indicating a DTX condition. Conversely, if the checksum error occurs and the combined symbol energies are above a selected low level, this indicates that symbols were actually sent by the mobile device. Note that as a practical matter, the energy difference between a DTX case and an erasure case is usually small and detectable only after summing together large numbers of symbols. Thus, the combined symbol energies indicating an erasure case may still be at a relatively low level.

To simplify the calculation of the metric shown in Equation 1, all of the terms in both the numerator and denominator in Equation 1 can be squared to obtain the following metric:

$$\frac{{\sum }_{Symb}^{} Soft\_Symbol {( Symb )}^{2}}{\begin{matrix}{Σ}_{ChanEstNum}^{} {\sum }_{Finger}^{} {‖ ChanEst ( ChanEstNum , Finger ) ‖}^{2} * \\ Combine ( ChanEstNum , Finger )\end{matrix}} \qquad ( Equation 2 )$$

Although Equations 1 and 2 are not mathematically equivalent, they exhibit similar performance in generating a metric that accurately distinguishes between erasures and DTXs by making the metric for a DTX substantially consistent, regardless of channel conditions. Equation 2 does not require any square root operation, making it easier to calculate than Equation 1.

Equations 1 and 2 both result in metrics that are well-defined and predictable for a DTX case. More particularly, greatly reducing the effects of channel conditions in the metric and detecting DTX cases based solely on the symbol energy reduces the variance of the metric that the DTX case will have. That is, because no symbols are being transmitted in the DTX case, any symbol energies above a low level will indicate that the checksum error is caused by an erasure and not a DTX, regardless of channel conditions.

FIG. 2 is a flow diagram illustrating one embodiment of the inventive method. In this embodiment, the base station receives the transmission from the mobile device (block 200), and uncovers and despreads this transmission separately for each finger (block 202) to produce precursor symbols for each selected finger. As noted above, the base station may ignore fingers deemed too weak for consideration (i.e., fingers having a Boolean Combine value of 0).

The base station 104 then derotates and scales the precursor symbols for each finger individually (block 204) until all of the desired fingers have been derotated and scaled (block 205). Once the base station has generated soft symbols for all of the selected fingers, the base station maximum ratio combines (MRC) the soft symbols for the individual fingers to generate soft symbols. The soft symbols are then combined to obtain an energy term (block 207) and then normalized to obtain a metric (block 208). This metric removes the overall effect of channel conditions on the soft symbols and is compared to the DTX detection threshold (block 210).

The embodiment shown in FIG. 2 normalizes the soft symbols at the end of the process, after the soft symbols have been generated and summed. In another embodiment, the base station may conduct the normalization process during the decoding process itself rather than in a separate process. To do this, the base station conducts the de-rotation and scaling step (block 204) using a normalized channel estimate rather than the channel estimate itself. Note that in this embodiment, the normalized channel estimate may remove the relative weighting among soft symbols because the soft symbols are normalized during the decoding process rather than at the end. However, this process also eliminates a separate normalization step, which may be desirable in certain applications.

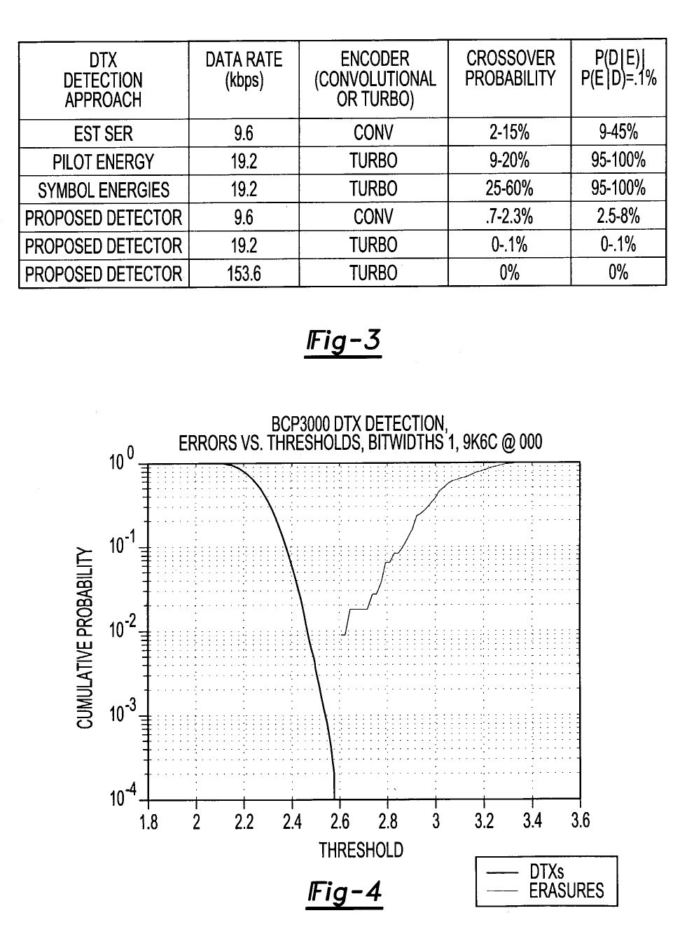

FIG. 3 is a table illustrating the performance characteristics of various DTX detection methods, including the inventive method. The table shows the effect of data rates and encoder types on performance as well. The DTX detector performance is evaluated by crossover probability, which is the probability of error when the DTX detection threshold is set so that probabilities of missed detection and false detection are equal; the higher the crossover probability, the worse the DTX detector performance is. Crossover probability can vary based on the channel conditions, such as the speed of mobile device movement with respect to the base station.

Performance is also measured by P(D|E)|P(E|D)=0.1%, or the threshold at which the probability of the algorithm falsely indicating an erasure case in a DTX case is 0.1%. The point at which this threshold is set affects the probability of error in falsely indicating a DTX case. Note that, for example, in the pilot energy and symbol energy detection approaches, the probability of a false erasure indication is nearly 100% when p(E|D) equals 0.1%; that is, these approaches declare that virtually all checksum errors are caused by a DTX. Although this ensures that few DTX cases are missed, the tradeoff is that nearly all erasure cases will be missed in the process.

The inventive method, by contrast, has crossover probabilities and false erasure detection probabilities that are very low and that become even lower as the data rate increases. Higher data rates require increased power to transmit the symbols, making the contrast between the high symbol energies of the erasure case and the low to non-existent symbol energies of the DTX case even more apparent and easier to detect.

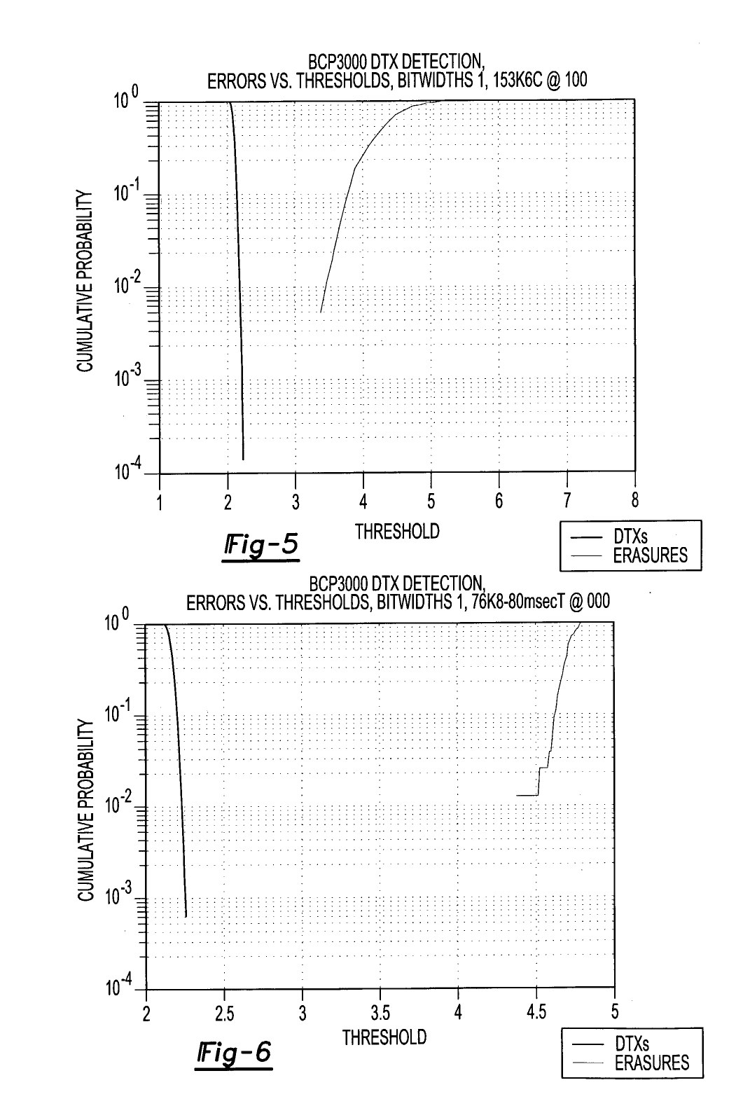

Another desirable result of the inventive method is that the desired threshold separating a DTX case from the erasure case is generally the same regardless of the data transmission rate. FIGS. 4 through 6 are error curves illustrating examples of DTX and erasure classification error probabilities vs. thresholds for various data rates. As can be seen in the Figures, the threshold that separates DTXs from erasures can be selected to be the same for a wide range of data rates. Although higher data rates result in the DTX and erasure histograms moving further apart (indicating improved DTX detection performance), a threshold of around 2.6 will produce reasonable results in all of the illustrated cases. This simplifies DTX detection even more because the detection method does not necessarily require a look-up table containing different threshold values for different data rates. However, a transmission rate based on a look-up table may further improve performance for certain applications.

As a result, the invention provides a simple, accurate way to distinguish erasures from DTXs by keeping the value of the symbol energy metric as constant as possible for all DTX situations, regardless of channel conditions. This information can provide accurate control and monitoring of communication system performance. For example, the system may increase a mobile device's transmission power if an erasure is detected and leave the transmission power alone if a DTX is detected; the invention ensures that proper action is taken when the base station detects a checksum error. Further, distinguishing erasures from DTXs accurately allows precise calculation of a frame error rate, which is an important measure of communication system performance.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, this method, system and portions thereof and of the described method and system may be implemented in different locations, such as network elements, the wireless unit, the base station, a base station controller, a mobile switching center and/or radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

We claim:

1. A method of determining whether a transmitted frame associated with a checksum error is caused by a discontinuous transmission, comprising:
combining soft symbols corresponding to the transmitted frame to obtain an energy term;
normalizing the energy term to obtain a metric, wherein the normalizing removes an effect of channel conditions on the energy term; and
comparing the metric with a threshold to determine whether the discontinuous transmission condition or an erasure has occurred.

2. The method of claim 1, wherein the energy term is a maximum ratio combining (MRC) energy term obtained via maximum ratio combining.

3. The method of claim 2, wherein the combining step generates the MRC energy term by summing absolute values of the soft symbols.

4. The method of claim 1, wherein the normalizing step comprises dividing the energy term by a normalizing factor.

5. The method of claim 4, wherein the normalizing factor is equal to a sum of finger-combined channel estimate norms.

6. The method of claim 5, wherein the soft symbols are received over a plurality of fingers, each finger having an associated finger channel estimate, and wherein each finger-combined channel estimate norm comprises a square root of a sum of squared finger channel estimate norms used to generate the soft symbols.

7. The method of claim 1, wherein the energy term is calculated by summing squares of the soft symbols.

8. The method of claim 7, wherein the normalizing step comprises dividing the energy term by a normalizing factor.

9. The method of claim 8, wherein the normalizing factor is equal to a sum of the square values of finger-combined channel estimate norms.

10. The method of claim 9, wherein the soft symbols are received over a plurality of fingers, each finger having an associated finger channel estimate, and wherein each finger-combined channel estimate norm comprises a square root of a sum of the squared norms of the finger channel estimates used to generate the soft symbols.

11. A method of determining whether a transmitted frame associated with a checksum error is caused by a discontinuous transmission, comprising:
combining soft symbols corresponding to the transmitted frame via constant ratio combining by summing soft symbol values to obtain a metric, wherein the combining step is conducted using a normalized channel estimate that removes an effect of a channel conditions on the metric; and
comparing the metric with a threshold to determine whether the discontinuous transmission condition or an erasure exists.

12. The method of claim 11, wherein the soft symbol values are absolute values of the soft symbols.

13. The method of claim 11, wherein the soft symbol values are squares of the soft symbols.

14. A method of determining whether a transmitted frame associated with a checksum error is caused by a discontinuous transmission, comprising:
obtaining soft symbols corresponding to the transmitted frame over a plurality of fingers;
conducting maximum ratio combining (MRC) on the soft symbols;
combining the soft symbols to obtain an MRC energy term;
dividing the MRC energy term by a normalizing factor to obtain a metric, wherein the normalizing removes an effect of the channel conditions on the energy term; and
comparing the metric with a threshold to determine whether the discontinuous transmission condition or an erasure has occurred.

15. The method of claim 14, wherein the obtaining step comprises at least one of derotating and scaling the transmission to generate the soft symbols.

16. The method of claim 14, further comprising selecting among said plurality of fingers and obtaining the soft symbols using the selected fingers.

17. The method of claim 14, wherein the combining step generates the MRC energy term by summing absolute values of the soft symbols computed during the transmitted frame.

18. The method of claim 17, wherein the normalizing factor is equal to a sum of finger combined channel estimate norms.

19. The method of claim 18, wherein each finger has an associated finger channel estimate, and wherein each finger-combined channel estimate norm comprises a square root of a sum of squared finger channel estimate norms used to generate the soft symbols.

20. The method of claim 14, wherein the energy term is calculated by summing squares of the soft symbols.

21. The method of claim 20, wherein the normalizing factor is equal to a sum of squares of the finger-combined channel estimate norms used to generate the energy term.

22. The method of claim 21, wherein each finger has an associated finger channel estimate, and wherein each finger-combined channel estimate norm comprises a square root of a sum of squared finger channel estimate norms used to generate the soft symbols.
